(19) United States
(12) Patent Application Publication
(10) Pub. No.: US 2021/0167984 A1
(43) Pub. Date: Jun. 3, 2021

(54) METHOD FOR CONTROLLING AN AIR CONDITIONER, COMMUNICATION CONTROL METHOD, AND COMMUNICATION SYSTEM

(71) Applicant: SUMITOMO ELECTRIC INDUSTRIES, LTD., Osaka (JP)

(72) Inventors: Junichi SHIRASU, Osaka (JP); Shunsuke MINESHIGE, Osaka (JP)

(73) Assignee: SUMITOMO ELECTRIC INDUSTRIES, LTD., Osaka (JP)

(21) Appl. No.: 17/174,597

(22) Filed: Feb. 12, 2021

Related U.S. Application Data
(62) Division of application No. 16/095,714, filed on Oct. 23, 2018.

(30) Foreign Application Priority Data
Apr. 25, 2016 (JP) 2016-087115

(51) Int. Cl. H04L 12/28; G06F 3/0482

(52) U.S. Cl. CPC H04L 12/2816; G06F 3/0482; H04L 2012/285; H04L 2012/2841; H04L 12/2809

(57) ABSTRACT

A device control system according to one aspect of the present disclosure includes a management apparatus that can communicate with a plurality of target devices which are management targets; and one or more terminal apparatuses that can communicate with the management apparatus and that control the target devices through communication with the management apparatus. The management apparatus includes: a management storage unit that stores an overall management table including pieces of identification information which are pieces of information by which the target devices can be identified, respectively, and device names which are names of the target devices set by a user; and a management control unit that controls communication with the terminal apparatus. The terminal apparatus includes: a terminal storage unit that stores a local table including the pieces of identification information of the target devices; and display priority levels indicating display priorities of the target devices, respectively; a display unit that displays the device names of the target devices; and a terminal control unit that controls communication with the management apparatus and display performed by the display unit. The management control unit transmits pieces of identification information and device names of some or all of the target devices which are included in the overall management table, to the terminal apparatus, and the terminal control unit controls the display unit to display the device names associated with the received pieces of identification information, according to corresponding display priority levels included in the local table.

### TECHNICAL FIELD

The present invention relates to a device control system, a management apparatus, a device control method, and a control program.

This application claims priority to Japanese Patent Application No. 2016-087115 filed Apr. 25, 2016, the entire content of which is incorporated herein by reference.

### BACKGROUND ART

Some energy consumption devices (home appliances) such as air conditioners and light fixtures which are installed in facilities such as standard homes and offices have a communication function. For example, as disclosed in Japanese Unexamined Patent Publication No. 2005-310022 (Patent Literature 1), there is known a system in which such devices are controlled (e.g., remote controlled) by a terminal apparatus carried by a user. As a communication standard between an apparatus serving as a controller and devices in such a system, ECHONET standard (Non-Patent Literature 1) is known.

By installing a dedicated application (program) on a terminal apparatus such as a smartphone or a tablet terminal, the terminal apparatus can be allowed to function as a controller for controlling devices.

### CITATION LIST

### Patent Literature

Patent Literature 1: Japanese Unexamined Patent Publication No. 2005-310022

### Non-Patent Literature

Non-Patent Literature 1: The ECHONET Lite Specification Version 1.12, ECHONET CONSORTIUM, Sep. 30, 2015)

### SUMMARY OF INVENTION

### Technical Problem

According to one embodiment, a device control system is a device control system including: a management apparatus that can communicate with a plurality of target devices, the plurality of target devices being management targets; and one or more terminal apparatuses that can communicate with the management apparatus and that control the target devices through communication with the management apparatus. The management apparatus includes: a management storage unit that stores an overall management table including pieces of identification information of the target devices and device names, the device names being names of the target devices set by a user; and a management control unit that controls communication with the terminal apparatus. The terminal apparatus includes: a terminal storage unit that stores a local table including the pieces of identification information of the target devices; and display priority levels indicating display priorities of the target devices, respectively; a display unit that displays the device names of the target devices; and a terminal control unit that controls communication with the management apparatus and display performed by the display unit. The management control unit transmits pieces of identification information and device names of some or all of the target devices to the terminal apparatus, the pieces of identification information and the device names being included in the overall management table, and the terminal control unit controls the display unit to display the device names associated with the received pieces of identification information, according to corresponding display priority levels included in the local table.

According to another embodiment, a management apparatus is a management apparatus that can communicate with a plurality of target devices, the plurality of target devices being management targets. The management apparatus includes: a management storage unit that stores an overall management table including pieces of identification information and device names, the identification information being information by which the target device can be identified, and the device name being a name of the target device set by a user; and a management control unit that controls communication with a terminal apparatus that controls the target devices through communication with the management apparatus. The management control unit transmits pieces of identification information and device names of some or all of the target devices to the terminal apparatus, the pieces of identification information and the device names being included in the overall management table.

According to still another embodiment, a device control method is a device control method performed by a device control system including a management apparatus that can communicate with a plurality of target devices, the plurality of target devices being management targets; and a terminal apparatus that can communicate with the management apparatus and that controls the target devices through communication with the management apparatus. The device control method includes the steps of: storing, by the management apparatus, an overall management table including pieces of identification information and device names, the identification information being information by which the target device can be identified, and the device name being a name of the target device set by a user; storing, by the terminal apparatus, a local table including the pieces of identification information of the target devices; and display priority levels indicating display priorities of the target device, respectively; transmitting, by the management apparatus, pieces of identification information and device names of some or all of the target devices to the terminal apparatus, the pieces of identification information and the device names being included in the overall management table; and displaying, by the terminal apparatus, the device names associated with the received pieces of identification information, according to corresponding display priority levels included in the local table.

According to yet another embodiment, a control program is a control program used by a management apparatus that can communicate with a plurality of target devices, the plurality of target devices being management targets. The control program causes a computer to function as: a management storage unit that stores an overall management table including pieces of identification information and device names, the identification information being information by which the target device can be identified, and the device name being a name of the target device set by a user; and a management control unit that controls communication with a terminal apparatus that controls the target devices through communication with the computer. The management control unit transmits pieces of identification information and device names of some or all of the target devices to the terminal apparatus, the pieces of identification information and the device names being included in the overall management table.

### BRIEF DESCRIPTION OF DRAWINGS

FIG. 1 is a diagram showing an overview of a configuration of a device control system (hereinafter, abbreviated as system) according to an embodiment.

FIG. 2 is a diagram showing an overview of another example of a configuration of a system according to the embodiment.

FIG. 3 is a block diagram showing an example of an apparatus configuration of a management apparatus included in the system.

FIG. 4 is a block diagram showing an example of an apparatus configuration of a terminal apparatus included in the system.

FIG. 5 is a diagram showing a summary of operation of the system performed when an electrical device is controlled using the terminal apparatus.

FIG. 6 is a diagram showing a summary of operation of the system performed when the electrical device is controlled using the terminal apparatus.

FIG. 7 is a diagram showing an example of a screen displayed on the terminal apparatus.

FIG. 8 is a diagram showing an example of a screen displayed on the terminal apparatus.

FIG. 9 is a diagram showing an example of a screen displayed on the terminal apparatus.

FIG. 10 is a diagram showing an example of an overall management table.

FIG. 11 is a diagram showing an example of a local table.

FIG. 12 is a block diagram showing an example of a functional configuration of the management apparatus.

FIG. 13 is a block diagram showing an example of a functional configuration of the terminal apparatus.

FIG. 14 is a diagram showing an example of a screen displayed on the terminal apparatus.

FIG. 15 is a diagram showing a summary of operation of the system performed when a device name is registered in the overall management table.

FIG. 16 is a diagram showing an example of a screen displayed on the terminal apparatus.

FIG. 17 is a diagram showing an example of a screen displayed on the terminal apparatus.

### DESCRIPTION OF EMBODIMENTS

### Problems to be Solved by the Present Disclosure

In the recent widespread of terminal apparatuses such as smartphones and tablet terminals, there may be a case in which a plurality of users present in a facility control devices installed in the facility, using terminal apparatuses carried by the respective users. For example, a case is assumed in which each of a plurality of family members controls home appliances in a home, using a smartphone carried by each family member. In this case, performing, by each of the plurality of users, an operation for registering target devices which are devices serving as control targets in an application, e.g., an operation for setting names of respective target devices and registering the names in an application, is not efficient because the same operation overlaps between the plurality of users.

In addition, since terminal apparatuses such as smartphones and tablet terminals have a small screen size, the amount of information that can be displayed is restricted. On the other hand, since there is an increasing trend in the number of energy consumption devices installed in facilities such as standard homes, there may be a case in which information indicating all devices in a facility cannot be displayed on one screen or it becomes difficult to see desired information if all are displayed. In that case, devices that are highly likely to be controlled may be displayed on a priority basis, but there is a case in which the display priorities of target devices differ between the users. Hence, if all of a plurality of terminal apparatuses included in the system display devices by applying the same priorities, then operations may be difficult for some users.

### Advantageous Effects of the Present Disclosure

According to the present disclosure, ease of operation for when a plurality of devices are controlled using a terminal apparatus can be improved.

### Summary of an Embodiment

First, the content of an embodiment of the present disclosure is listed and described.

A device control system included in the embodiment is a device control system including: a management apparatus that can communicate with a plurality of target devices, the plurality of target devices being management targets; and one or more terminal apparatuses that can communicate with the management apparatus and that control the target devices through communication with the management apparatus. The management apparatus includes: a management storage unit that stores an overall management table including pieces of identification information and device names, the identification information being information by which the target device can be identified, and the device name being a name of the target device set by a user; and a management control unit that controls communication with the terminal apparatus. The terminal apparatus includes: a terminal storage unit that stores a local table including the pieces of identification information of the target devices; and display priority levels indicating display priorities of the target devices, respectively; a display unit that displays the device names of the target devices; and a terminal control unit that controls communication with the management apparatus and display performed by the display unit. The management control unit transmits pieces of identification information and device names of some or all of the target devices to the terminal apparatus, the pieces of identification information and the device names being included in the overall management table, and the terminal control unit controls the display unit to display the device names associated with the received pieces of identification information, according to corresponding display priority levels included in the local table.

In a terminal apparatus included in the device control system, device names included in the overall management table stored in the management apparatus are displayed according to display priority levels included in a local table stored on a per-terminal-apparatus basis. Hence, an operation for registering a device name by individual terminal apparatuses is not required. By this, the operation efficiency of a user of each terminal apparatus can be improved. In addition, since device names are displayed in a display format determined based on display priority levels set on a per-terminal-apparatus basis, device names can be displayed in a user's desired display format. By this, ease of operation by a user who controls target devices using a terminal apparatus can be improved.

Preferably, when the terminal control unit accepts a user operation for setting a device name of a target device, the terminal control unit transmits the device name together with identification information of the target device to the management apparatus.

By this, a device name of a target device is registered in the overall management table by a request from any of the terminal apparatuses included in the device control system. Hence, an operation for requesting registration of a device name by individual terminal apparatuses is not required. By this, the operation efficiency of a user of each terminal apparatus can be improved.

Preferably, the device control system includes two or more terminal apparatuses, and the management control unit transmits identification information and a device name of a target device to a second terminal apparatus, the identification information and the device name being received from a first terminal apparatus and registered in the overall management table.

By this, a device name is registered in the overall management table by a request from any of the terminal apparatuses included in the device control system, and other terminal apparatuses included in the device control system can also use the device name for display. Hence, an operation for registering a device name by individual terminal apparatuses is not required. By this, the operation efficiency of a user of each terminal apparatus can be improved.

Preferably, the device control system includes two or more terminal apparatuses, and different display priority levels can be associated with pieces of identification information of identical target devices in a first local table stored in a terminal storage unit of a first terminal apparatus and a second local table stored in a terminal storage unit of a second terminal apparatus.

Hence, device names can be displayed using display priority levels that differ between the terminal apparatuses. By this, by setting higher display priority levels for devices that are highly likely to serve as target devices of a user who controls target devices using a terminal apparatus, a user's desired target device can be quickly found. By this, ease of operation by a user of each terminal apparatus can be improved.

Preferably, the local table further includes pieces of information identifying types into which the target devices are classified, and the display priority levels in the local table include first priority levels, the first priority levels being display priorities of a plurality of target devices classified into a same type.

By this, it becomes possible to display device names using display priorities set on a per-type basis. Hence, a user can quickly find his/her desired target device. By this, the operation efficiency of a user of each terminal apparatus can be improved.

Preferably, the display priority levels in the local table further include second priority levels, the second priority levels being display priorities of a plurality of target devices classified into different types.

By this, it becomes possible to display device names using display priorities set regardless of type. Even if target devices are of different types, for example, by setting display priorities for devices that are highly likely to serve as target devices to be controlled by a user, the user can more quickly find his/her desired target device. By this, the operation efficiency of a user of each terminal apparatus can be improved.

Preferably, when the terminal control unit accepts a user operation for instructing to register a new device name in the overall management table, the terminal control unit requests the management apparatus for the registration, in response to the request, the management control unit transmits identification information of one or more corresponding target devices to the terminal apparatus having made the request, and the terminal control unit controls the display unit to display a screen for accepting setting of the new device name, based on the received identification information.

By this, a device name is registered in the overall management table by a request from any of the terminal apparatuses included in the device control system. Hence, an operation for registering a device name by individual terminal apparatuses is not required. By this, the operation efficiency of a user of each terminal apparatus can be improved.

Preferably, in response to the request, the management control unit searches for a target device whose identification information is not registered in the overall management table, as the corresponding target device, and registers identification information of the target device in the overall management table.

By this, only by a user of a terminal apparatus providing an instruction to the terminal apparatus, newly installed target devices are automatically searched for by the management apparatus. By this, the operation efficiency of a user of each terminal apparatus can be improved.

Preferably, the overall management table further includes information identifying registration order of the identification information in the overall management table, in response to the request, the management control unit transmits the identification information and information of the corresponding target device to the terminal apparatus, the information identifying the registration order, and the terminal control unit controls the display unit such that information based on the received identification information is displayed on the screen for accepting setting of the device name, according to the registration order.

By this, pieces of information based on pieces of identification information of corresponding target devices are displayed in display order that follows the order in which the pieces of identification information are registered in the overall management table. Hence, even if pieces of information about a plurality of target devices are displayed on a screen for accepting setting of a device name, a user can easily find a target device serving as a target for setting a device name. By this, the operation efficiency of a user of each terminal apparatus can be improved.

Preferably, when the terminal control unit accepts a predefined user operation on the screen for accepting setting of the device name, the terminal control unit requests the management apparatus to allow a target device specified by the user operation to perform a predefined informing action.

By this, when a user of a terminal apparatus does not know correspondence between information and a target device which are displayed on a screen for accepting setting of a device name, the user can understand the correspondence by identifying an informing action by the target device.

A management apparatus included in the embodiment is a management apparatus that can communicate with a plurality of target devices, the plurality of target devices being management targets. The management apparatus includes: a management storage unit that stores an overall management table including pieces of identification information and device names, the identification information being information by which the target device can be identified, and the device name being a name of the target device set by a user; and a management control unit that controls communication with a terminal apparatus that controls the target devices through communication with the management apparatus. The management control unit transmits pieces of identification information and device names of some or all of the target devices to the terminal apparatus, the pieces of identification information and the device names being included in the overall management table.

Since the overall management table is stored in the management apparatus and the device names of some or all of the target devices are provided to a terminal apparatus, device names do not need to be registered on a per-terminal-apparatus basis. Namely, an operation for registering a device name by individual terminal apparatuses is not required. By this, the operation efficiency of a user of each terminal apparatus can be improved. In addition, since device names are displayed in a display format determined based on display priority levels stored on the terminal apparatus side, device names can be displayed in a display format desired by a user who performs control. By this, ease of operation by a user who controls target devices using a terminal apparatus can be improved.

A device control method included in the embodiment is a device control method performed by a device control system including a management apparatus that can communicate with a plurality of target devices, the plurality of target devices being management targets; and a terminal apparatus that can communicate with the management apparatus and that controls the target devices through communication with the management apparatus. The device control method includes the steps of; storing, by the management apparatus, an overall management table including pieces of identification information and device names, the identification information being information by which the target device can be identified, and the device name being a name of the target device set by a user; storing, by the terminal apparatus, a local table including the pieces of identification information of the target devices; and display priority levels indicating display priorities of the target device, respectively; transmitting, by the management apparatus, pieces of identification information and device names of some or all of the target devices to the terminal apparatus, the pieces of identification information and the device names being included in the overall management table; and displaying, by the terminal apparatus, the device names associated with the received pieces of identification information, according to corresponding display priority levels included in the local table.

In a terminal apparatus included in the device control system, device names included in the overall management table stored in the management apparatus are displayed in a display format determined based on display priority levels included in a local table which is stored on a per-terminal-apparatus basis. Hence, an operation for registering a device name by individual terminal apparatuses is not required. By this, the operation efficiency of a user of each terminal apparatus can be improved. In addition, since device names are displayed in a display format determined based on display priority levels set on a per-terminal-apparatus basis, device names can be displayed in a display format desired by a user who performs. By this, ease of operation by a user who controls target devices using a terminal apparatus can be improved.

A control program included in the embodiment is a control program used by a management apparatus that can communicate with a plurality of target devices, the plurality of target devices being management targets. The control program causes a computer to function as: a management storage unit that stores an overall management table including pieces of identification information and device names, the identification information being information by which the target device can be identified, and the device name being a name of the target device set by a user; and a management control unit that controls communication with a terminal apparatus that controls the target devices through communication with the computer. The management control unit transmits pieces of identification information and device names of some or all of the target devices to the terminal apparatus, the pieces of identification information and the device names being included in the overall management table.

Since the overall management table is stored in the computer that is caused to function as the management apparatus by the control program and the device names of some or all of the target devices are provided to a terminal apparatus, device names do not need to be registered on a per-terminal-apparatus basis. Namely, an operation for registering a device name by individual terminal apparatuses is not required. By this, the operation efficiency of a user of each terminal apparatus can be improved. In addition, since device names are displayed in a display format determined based on display priority levels stored on the terminal apparatus side, device names can be displayed in a display format desired by a user who performs control. By this, ease of operation by a user who controls target devices using a terminal apparatus can be improved.

### DETAILS OF EMBODIMENTS

Preferred embodiments will be described below with reference to the drawings. In the following description, the same parts and components are denoted by the same reference signs.

### First Embodiment

<System Configuration>

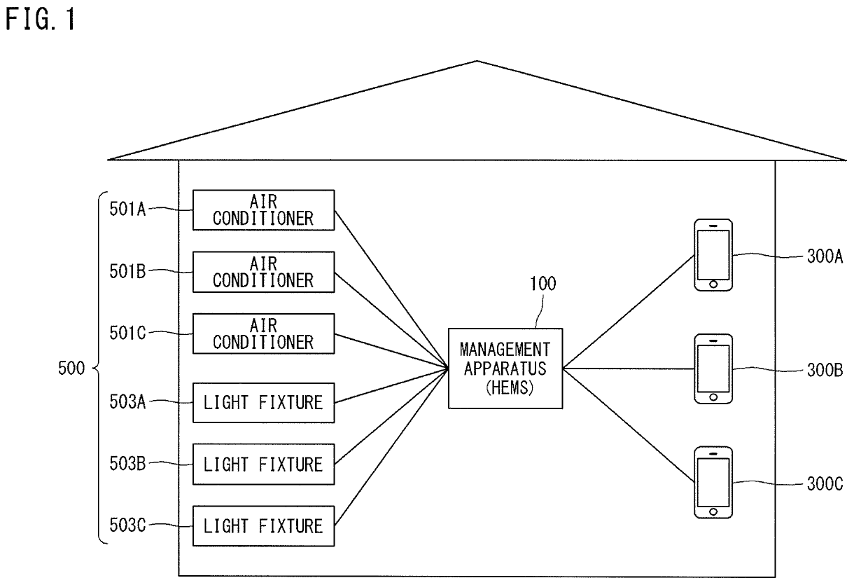

FIG. 1 is a diagram showing an overview of a configuration of an electrical device control system (hereinafter, abbreviated as system) according to the present embodiment.

With reference to FIG. 1, the system includes a plurality of energy consumption devices which are installed in a facility such as a standard home or an office. Namely, the system includes, for example, air conditioners 501A, 501B, and 501C and, for example, light fixtures 503A, 503B, and 503C, as a plurality of energy consumption devices (e.g., electrical devices). Furthermore, the system includes a management apparatus 100 whose management targets are those devices; and a plurality of terminal apparatuses 300A, 300B, and 300C carried by users. The air conditioners 501A, 501B, and 501C are also representatively referred to as air conditioners 501. The light fixtures 503A, 503B, and 503C are also representatively referred to as light fixtures 503. In addition, the air conditioners 501A, 501B, and 501C and the light fixtures 503A, 503B, and 503C are also representatively referred to as electrical devices 500. In addition, the plurality of terminal apparatuses 300A, 300B, and 300C are also representatively referred to as terminal apparatuses 300.

The electrical devices 500 which are examples of energy consumption devices are classified into electric water heaters, storage batteries, electric vehicles, television receivers, surveillance cameras, and the like, in addition to the exemplified air conditioners 501 and light fixtures 503. The electrical devices 500 each have a normal electrical device function and a function of communicating with the management apparatus 100. Communication between the electrical devices 500 and the management apparatus 100 is, for example, wireless communication complying with standards such as a wireless local area network (LAN) and ZigBee (registered trademark).

When an electrical device 500 receives a control signal instructing to set and change parameters such as ON/OFF, a set temperature, and a mode of operation from the management apparatus 100, the electrical device 500 sets or changes the ON/OFF, set temperature, or mode of operation thereof according to the control signal. In addition, when the electrical device 500 receives a signal requesting the above-described parameters from the management apparatus 100, the electrical device 500 transmits parameters such as set values thereof to the management apparatus 100 according to the signal.

Each terminal apparatus 300 is an apparatus that can be carried by a user and is, for example, a smartphone, a tablet terminal, etc. The terminal apparatus 300 also has a function of communicating with the management apparatus 100. Communication between the terminal apparatus 300 and the management apparatus 100 is, for example, short-distance wireless communication such as a wireless LAN.

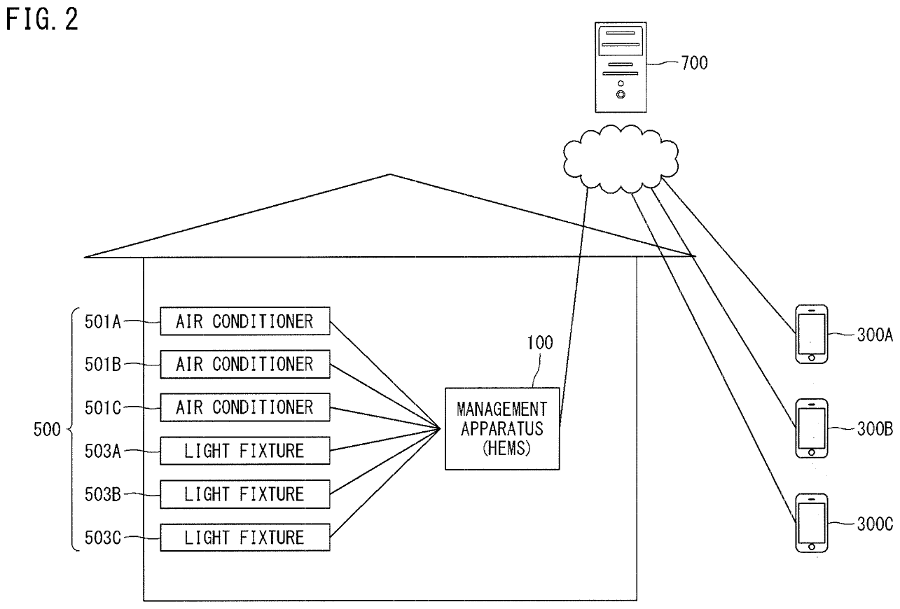

Note that in addition to the case of performing direct wireless communication between the terminal apparatuses 300 and the management apparatus 100 as shown in FIG. 1, for example, when, as shown in FIG. 2, the terminal apparatuses 300 are present outside a range in which the terminal apparatuses 300 can wirelessly communicate with the management apparatus 100 such as a case in which the users carrying the terminal apparatuses 300 are out, the terminal apparatuses 300 and the management apparatus 100 may communicate with each other through a server 700. In this case, the management apparatus 100 and the server 700 communicate with each other through a communication network such as the Internet. When a terminal apparatus 300 has a telephone function, the terminal apparatus 300 and the server 700 communicate with each other, for example, using the telephone line. By enabling such communication, even when a terminal apparatus 300 is out of the range in which the terminal apparatus 300 can wirelessly communicate with the management apparatus 100, the terminal apparatus 300 can be connected to the system.

<Apparatus Configurations>

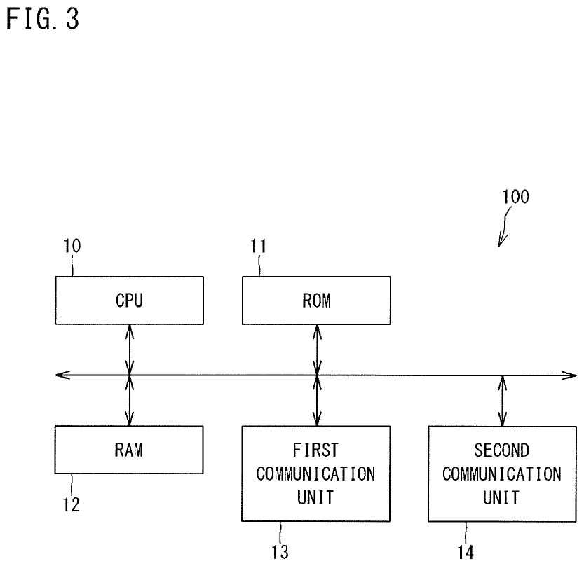

FIG. 3 is a block diagram showing an example of an apparatus configuration of the management apparatus 100. With reference to FIG. 3, the management apparatus 100 includes a central processing unit (CPU) 10 which is a management control unit for controlling the entire apparatus; a read only memory (ROM) 11 for storing programs which are executed by the CPU 10, and various types of information; a random access memory (RAM) 12 serving as a work area used when a program is executed by the CPU 10; a first communication unit 13 for controlling communication with the terminal apparatuses 300; and a second communication unit 14 for controlling communication with the electrical devices 500. Note that in addition to the configuration shown in FIG. 3, the management apparatus 100 may further include input apparatuses such as buttons and display apparatuses such as a display and a lamp.

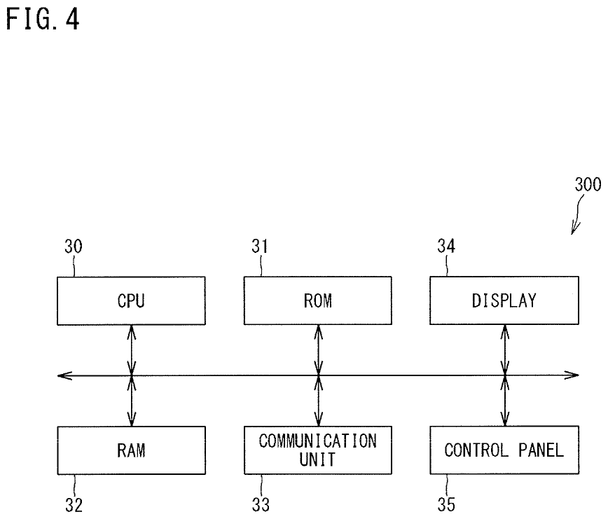

FIG. 4 is a block diagram showing an example of an apparatus configuration of the terminal apparatus 300. With reference to FIG. 4, the terminal apparatus 300 includes a CPU 30 which is a terminal control unit for controlling the entire apparatus; a ROM 31 for storing programs which are executed by the CPU 30, and various types of information; a RAM 32 serving as a work area used when a program is executed by the CPU 30; a communication unit 33 for controlling communication with the management apparatus 100; a display 34; and a control panel 35. Note that the configuration shown in FIG. 4 is a configuration of a general computer. Hence, when a terminal apparatus 300 is, for example, a smartphone or a tablet terminal, the terminal apparatus 300 may have a configuration for functioning as those apparatuses, in addition to the configuration shown in FIG. 4.

<Summary of Operation>

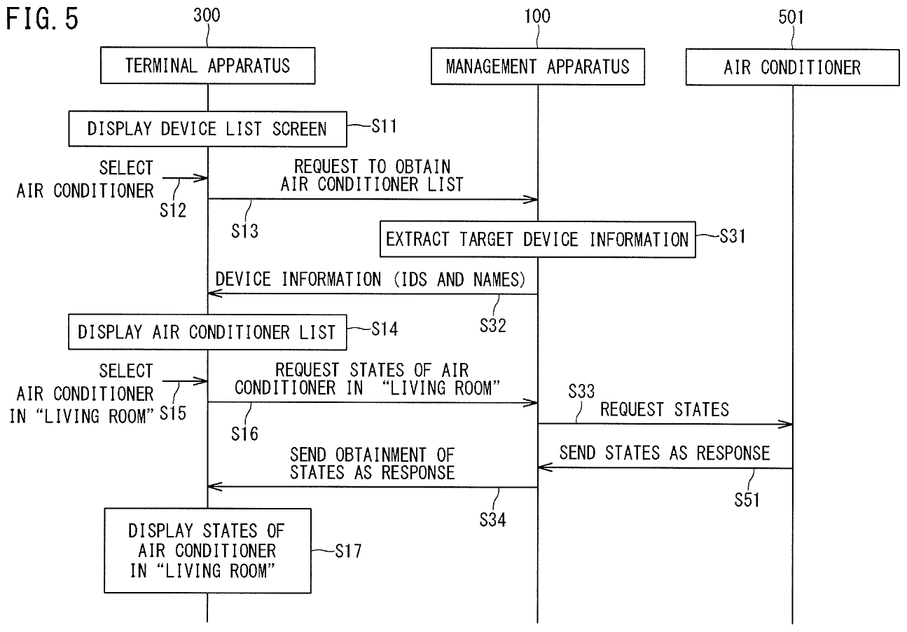

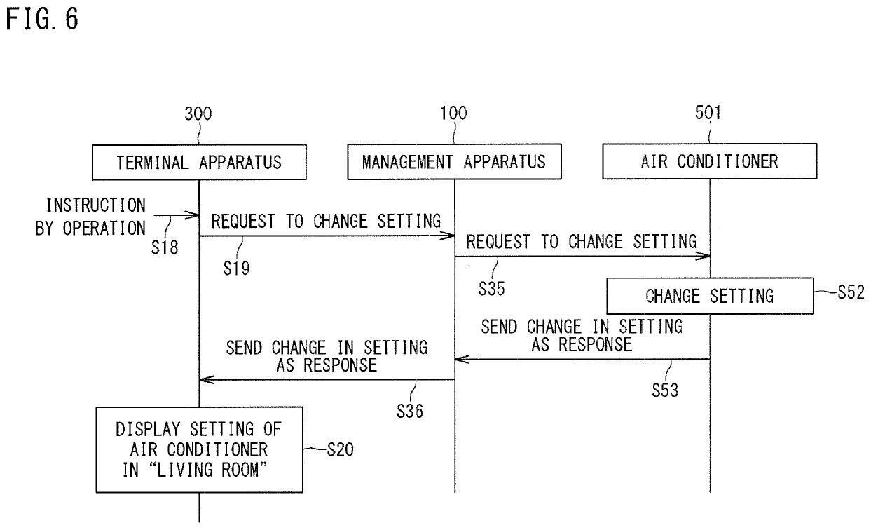

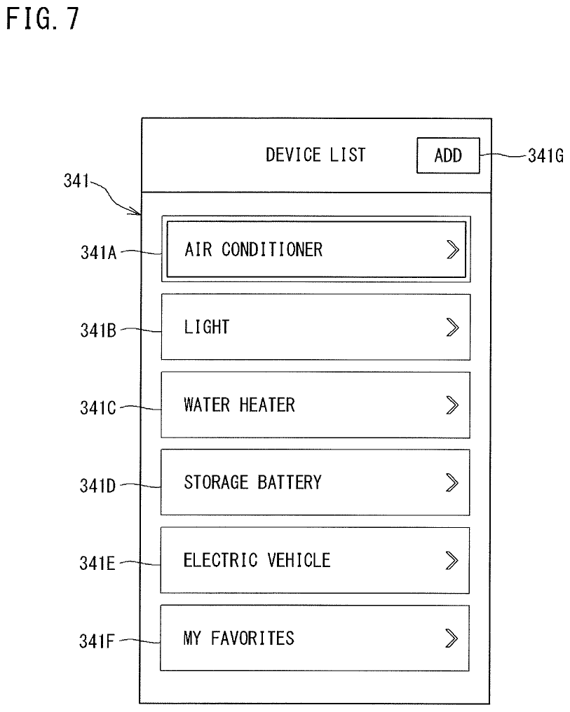

In the system, a user can control (e.g., remote control) the electrical devices 500 using a terminal apparatus 300 as a controller for the electrical devices 500. FIGS. 5 and 6 are diagrams showing, as an example, a summary of operation of the system for controlling an air conditioner 501 installed in the facility by the user using the terminal apparatus 300. FIGS. 7 to 9 are diagrams showing examples of screens displayed on the terminal apparatus 300. Operation of FIG. 5 starts when the terminal apparatus 300 accepts a user operation instructing to display a list of electrical devices (device list) installed in the facility. Note that the instruction to display a device list can be provided, for example, on a home screen of a system for managing the power of various types of electrical devices installed in a facility, which is called Home Energy Management System (HEMS), etc. In other words, the system may be a system included in HEMS, and a home screen thereof may include a button for instructing to display a device list to control each electrical device.

With reference to FIG. 5, when the above-described user operation is performed on the terminal apparatus 300, a device list is displayed on the display 34 of the terminal apparatus 300 (step S11). FIG. 7 is a diagram showing an exemplary screen for a device list. With reference to FIG. 7, the device list screen displayed on the display 34 includes an area 341 for displaying a list of types of electrical devices 500 installed in the facility. In the area 341 there are displayed, as the types of electrical devices 500, for example, an icon 341A representing an air conditioner, an icon 341B representing a light fixture, an icon 341C representing an electric water heater, an icon 341D representing a storage battery, and an icon 341E representing an electric vehicle. Information for displaying these icons, i.e., information indicating the types of electrical devices 500 installed in the facility, may be p restored in a memory such as the ROM 31 of the terminal apparatus 300. In this case, at step S11, the CPU 30 reads the information from the memory and can perform display of FIG. 7. Alternatively, at step S11, the terminal apparatus 300 may request the management apparatus 100 for information indicating the types of electrical devices 500 installed in the facility, and perform display of FIG. 7 based on the information obtained from the management apparatus 100.

When, as shown in FIG. 7, for example, an air conditioner is selected from the device list, i.e., when the icon 341A is touched (step S12), information for displaying a list of the air conditioners 501 among the electrical devices 500 installed in the facility is requested from the terminal apparatus 300 to the management apparatus 100 (step S13).

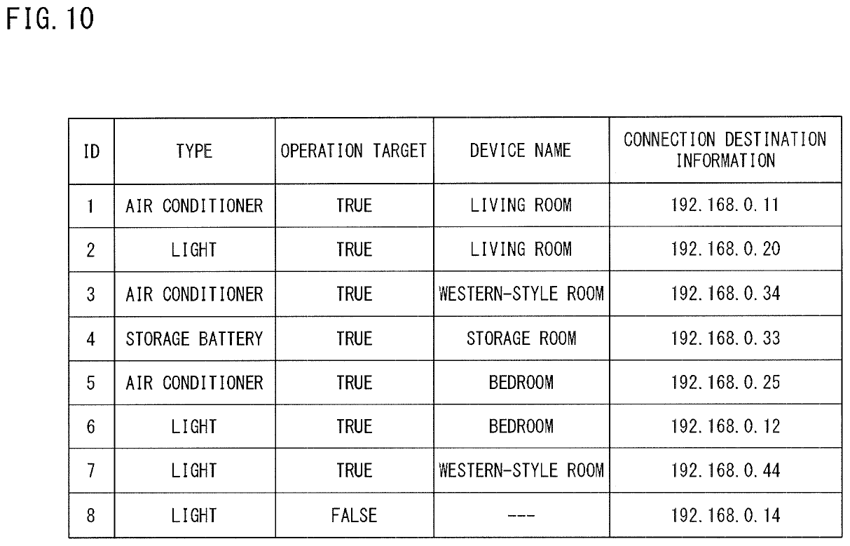

The management apparatus 100 stores an overall management table in a memory such as the ROM 11. In other words, a storage area for storing the overall management table is prepared in the memory of the management apparatus 100. FIG. 10 is a diagram showing an example of an overall management table. With reference to FIG. 10, the overall management table includes identification information (ID) for each electrical device 500 installed in the facility; and a device name which is a name set by a user for the electrical device 500. Preferably, the overall management table includes a type into which the electrical device 500 is classified. Furthermore, the overall management table may include, for example, a target flag (TRUE/FALSE) which is information indicating whether the electrical device is a control target of the terminal apparatuses 300 included in the system; connection destination information for the second communication unit 14; currently set parameters such as ON/OFF, a set temperature, and a mode of operation; and information unique to the device such as the media access control (MAC) address, serial number, and manufacturing number of the electrical device 500.

In response to the request at the above-described step S13, the management apparatus 100 extracts the pieces of identification information and device names of the air conditioners 501 from the overall management table of FIG. 10 (step S31). When, as shown in FIG. 10, the overall management table includes the above-described target flags, at step S31, the pieces of identification information and devices names of air conditioners 501 that are air conditioners 501 and that are control targets (TRUE) of the terminal apparatuses 300 included in the system are extracted from the memory. The extracted pieces of identification information and device names for the respective corresponding air conditioners 501 are transmitted as device information from the management apparatus 100 to the terminal apparatus 300 (step S32).

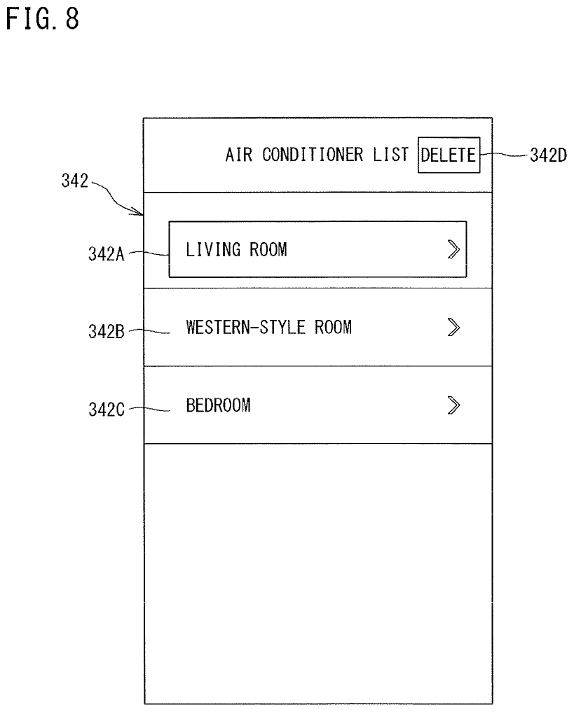

When the above-described device information is obtained from the management apparatus 100, a list of a plurality of electrical devices 500 serving as candidate devices which are candidates for electrical devices serving as control targets of the terminal apparatus 300 is displayed in list format on the display 34 of the terminal apparatus 300 (step S14). FIG. 8 is a diagram showing an exemplary screen for an air conditioner list showing air conditioners serving as candidate devices to be controlled by the terminal apparatus 300, which is displayed on the display 34 of the terminal apparatus 300 at the above-described step S14 when the type “air conditioner” is selected in the device list of FIG. 7. With reference to FIG. 8, the air conditioner list displayed on the display 34 includes an area 342 for displaying a list of the device names of the air conditioners 501 that are installed in the facility and that serve as candidate devices to be controlled by the terminal apparatus 300. In the area 342 there are displayed, for example, an icon 342A representing the device name “living room” of a given air conditioner; an icon 342B representing the device name “Western-style room” of another air conditioner; and an icon 342C representing the device name “bedroom” of still another air conditioner.

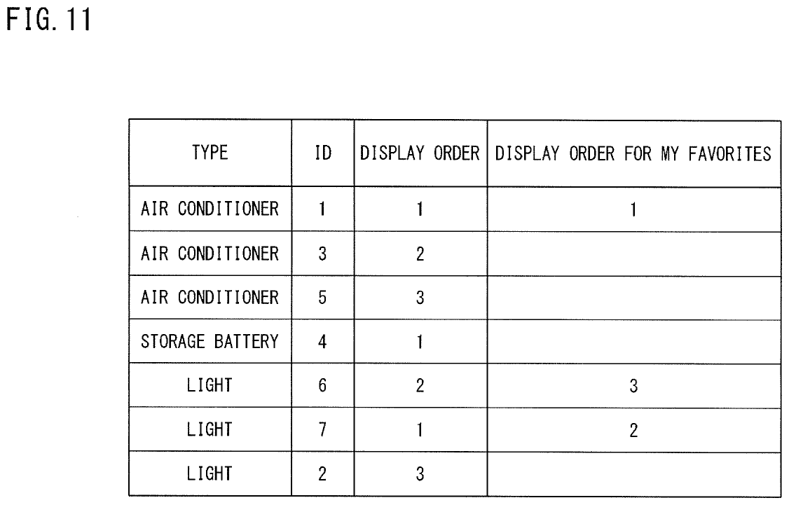

For example, when device information from the management apparatus 100 is device information of an air conditioner 501 that is not registered in a local table of the terminal apparatus 300, at step S14, an icon representing a device name of the air conditioner 501 is displayed at the lowest priority on the air conditioner list. That is, in the terminal apparatus 300, when device information obtained from the management apparatus 100 after selecting a given type from the device list of FIG. 7 is device information of an electrical device 500 that is not registered in the local table (FIG. 11), the electrical device 500 is newly registered in (added to) the local table at the lowest (or highest) position in the display order of electrical devices 500 of the same type as the electrical device 500 which are already registered in the local table.

In addition, for example, when device information of an air conditioner 501 registered in the local table of the terminal apparatus 300 is not included in the device information from the management apparatus 100, at step S14, an icon representing a device name of the air conditioner 501 is not displayed in the air conditioner list. That is, in the terminal apparatus 300, when device information of an electrical device 500 registered in the local table (FIG. 11) is not included in device information obtained from the management apparatus 100 after selecting a given type from the device list of FIG. 7, the electrical device 500 is deleted from the local table. In addition, the electrical device 500 is not displayed on the terminal apparatus 300.

To display the air conditioner list of FIG. 8 on a screen, at step S14, the terminal apparatus 300 determines display priorities of the icons 342A to 342C to be displayed in the area 342. As an example, the display priorities are display positions, i.e., display order. Other examples of the display priorities include the order of magnitude of display size and the order of display colors (a high-visibility color, a low-visibility color, etc.). In the case of the example of FIG. 8, the icon 342A has the highest display priority, followed by the icon 342B and then the icon 342C. Namely, at step S14, the terminal apparatus 300 determines the display order, in the area 342, of the device names “living room”, “Western-style room”, and “bedroom” to be displayed in the air conditioner list, and displays the icons 342A to 342C in a display format that follows the order (e.g., in order from top).

To determine the display order in the terminal apparatus 300, the terminal apparatus 300 has a local table that is stored in a memory such as the ROM 31 on a per-terminal-apparatus-300 basis. In other words, a storage area for storing a local table for determining display order in the terminal apparatus 300 is prepared in the memory of the terminal apparatus 300. FIG. 11 is a diagram showing an example of a local table. With reference to FIG. 11, the local table includes identification information (ID) of an electrical device 500 serving as a candidate device in the terminal apparatus 300; and a display priority, i.e., a display priority level indicating display order, of the electrical device 500. By the display order being associated with the IDs in the local table, electrical devices 500 are uniquely identified in the overall management table (FIG. 10) stored in the memory of the management apparatus 100 and in the local table (FIG. 11) stored in the memory of the terminal apparatus 300, which are used upon performing display on the terminal apparatus 300. Hence, accurate display can be implemented while the amount of information stored in the memories of both devices is suppressed. Preferably, the local table further includes the type of an electrical device 500 serving as a candidate device. By the local table including types for each electrical device 500, display order can be defined for each type. Hence, as will be described later, the device names of electrical devices 500 can be displayed in display order defined for each type. This enables the user of the terminal apparatus 300 to quickly find his/her desired electrical device 500.

Note that the local table differs between the terminal apparatuses 300. Namely, different display orders are defined for the same electrical device 500 in a local table stored in the memory of the terminal apparatus 300A and a local table stored in the memory of the terminal apparatus 300B. Hence, the display order of electrical devices 500 serving as candidates for a control target at the above-described step S14 differs between the terminal apparatuses 300. The display order can be set or changed by a user operation on the terminal apparatus 300 as will be described later. For example, higher display priorities may be set for electrical devices with a higher frequency of control performed on the terminal apparatus 300 by the user of the terminal apparatus 300. In addition, as another example, higher display priorities may be set for electrical devices with a smaller amount of energy consumption. By thus allowing the terminal apparatuses 300 to have different display orders, electrical devices 500 serving as candidates for a control target are allowed to be displayed in the order desired by the user of each terminal apparatus 300. For example, by displaying, as described above, electrical devices 500 in the order in which the electrical devices 500 are frequently controlled by the user using the terminal apparatus 300, electrical devices 500 that are highly likely to be selected by the user are displayed at upper positions. In this case, the possibility that the user can find his/her desired electrical device 500 without having to check the display further down increases. That is, ease of operation by the user is improved.

At step S14, the terminal apparatus 300 reads IDs and device names for each air conditioner 501 from the device information of the air conditioners 501 transmitted from the management apparatus 100 at step S32. In addition, the terminal apparatus 300 reads the display order of each air conditioner 501 from the local table of FIG. 11 which is stored in the memory of the terminal apparatus 300, based on the IDs of the air conditioners 501. That is, the terminal apparatus 300 associates the device names and the display order, using the IDs registered in both the overall management table and the local table. Then, the terminal apparatus 300 displays the icons 342A to 342C representing the device names of the respective air conditioners in the area 342 in list format, according to the display order read from the local table.

Specifically, with reference to FIG. 10, at the above-described step S32, as the device information of the air conditioners 501, the ID “1” and the device name “living room”, the ID “3” and the device name “Western-style room”, and the ID “5” and the device name “bedroom” are transmitted from the management apparatus 100 to the terminal apparatus 300. At the above-described step S14, the terminal apparatus 300 having the local table of FIG. 11 stored therein determines the display order of the air conditioners 501 such that ID “1”→ID “3”→ID “5”, by referring to the local table of FIG. 11. Then, the terminal apparatus 300 displays the icon 342A for the device name “living room”,→the icon 342B for “Western-style room”,→the icon 342C “bedroom” in list format, for example, from top in the area 342 of the display screen, according to the above-described order of IDs (FIG. 8).

Note that, as described above, the display order of electrical devices 500 defined in the local table of FIG. 11 may be allowed to be changed according to a user operation on the terminal apparatus 300 storing the local table. For example, on the list display screen (FIG. 8) in which the icons 342A to 342C are displayed in display order defined in the local table, when a user operation for dragging any of the icons 342A to 342C to switch its position in display order to the position of another icon is accepted, the local table may be updated such that the display order set for the air conditioners 501 is changed to one according to the user operation.

For example, when the icon 342B representing the air conditioner in the “bedroom” is dragged above the icon 342A representing the air conditioner in the “living room” on the terminal apparatus 300 having the list display screen of FIG. 8 displayed thereon, in the local table of FIG. 11 stored in the terminal apparatus 300, the position in display order of the air conditioner with the ID “1” (the device name “living room”) is changed from 2 to 1, and the position in display order of the air conditioner with the ID “3” (the device name “Western-style room”) is changed from 1 to 2.

When, as shown in FIG. 8, for example, the air conditioner in the “living room” is selected from the air conditioner list, i.e., when the icon 342A is touched (step S15), information for displaying a control screen used to control the air conditioner in the “living room” is requested from the terminal apparatus 300 to the management apparatus 100 (step S16). At step S16, parameters representing the ON/OFF state and states such as a mode of operation and a set temperature of the air conditioner to be displayed on the control screen are requested.

The management apparatus 100 having received the request requests the corresponding air conditioner 501 for parameters representing the above-described states (step S33), and obtains the parameters from the air conditioner 501 (step S51). By this, the management apparatus 100 can send, as a response, the latest parameters of the corresponding air conditioner 501 to the terminal apparatus 300. Alternatively, when the management apparatus 100 communicates with the air conditioners 501 at predetermined timing and stores parameters, etc., in the memory, in response to the request from the terminal apparatus 300, the management apparatus 100 may read parameters of a corresponding air conditioner 501 from the memory. By this, an increase in communication in the system can be suppressed.

The management apparatus 100 transmits the parameters representing the states of the corresponding air conditioner 501 to the terminal apparatus 300, in response to the request from the terminal apparatus 300 (step S34). The terminal apparatus 300 displays a control screen for controlling the selected air conditioner in the “living room”, using the information (step S17). Namely, at step S17, the terminal apparatus 300 embeds the parameters obtained from the management apparatus 100 in a format of a control screen for air conditioners which is prestored in the memory, and thereby displays a control screen for controlling the air conditioner in the “living room”.

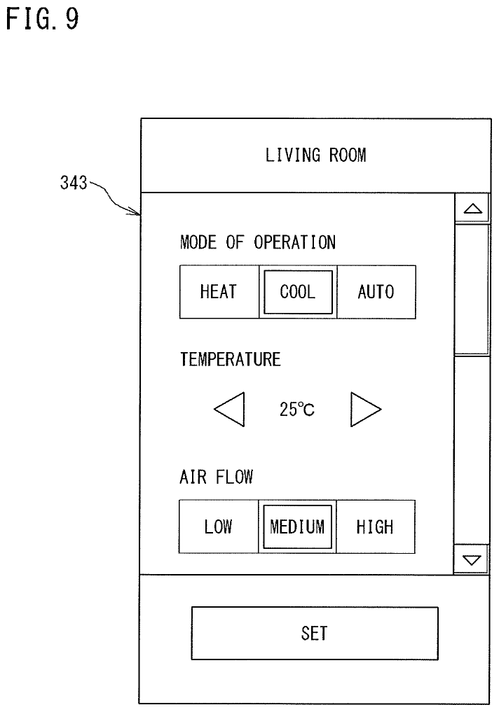

FIG. 9 is a diagram showing a specific example of a control screen for controlling the air conditioner in the “living room”. With reference to FIG. 9, the air conditioner control screen includes an area 343 for displaying various parameters set on the air conditioner and displaying icons that accept instructions to change the parameters. The types of icons in the area 343, etc., are not limited to those shown in FIG. 9. The user can control the air conditioner in the “living room” using the control screen of FIG. 9 displayed on the display 34 of the terminal apparatus 300.

Specifically, with reference to FIG. 6, when the user changes a parameter of the air conditioner 501, e.g., changing the temperature of the air conditioner in the “living room”, the user performs an operation on the control screen of FIG. 9. When the terminal apparatus 300 accepts a user operation on the control screen of FIG. 9 (step S18), the terminal apparatus 300 requests the management apparatus 100 for the instructed change (step S19).

When the management apparatus 100 accepts the above-described request from the terminal apparatus 300, the management apparatus 100 outputs a control signal for making the instructed parameter change to the corresponding air conditioner 501 and thereby requests a change in setting (step S35).

The air conditioner 501 changes the set parameter according to the control signal from the management apparatus 100 (step S52). Preferably, when the air conditioner 501 has changed the parameter according to the control signal from the management apparatus 100, the air conditioner 501 notifies the management apparatus 100 of the result of the change (step S53). More preferably, the notification includes the value of the changed parameter. The management apparatus 100 having received the notification preferably notifies the terminal apparatus 300 having made the above-described request of the result of the change (step S36). On the terminal apparatus 300 having received the notification, preferably, is displayed the fact that the change in the parameter of the air conditioner in the “living room” has been completed (step S20). More preferably, the changed parameter is displayed on a screen displayed on the terminal apparatus 300 at step S20. By this, the user having controlled the air conditioner in the “living room” using the terminal apparatus 300 can confirm by the display performed on the terminal apparatus 300 at step S20 that the instructed change in parameter, such as a set temperature, of the air conditioner 501 has been made.

<Functional Configuration>

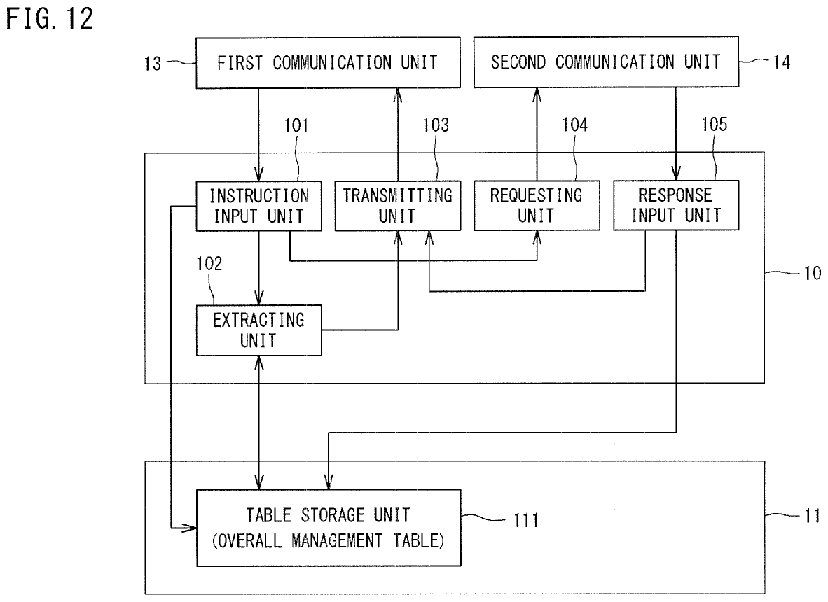

FIG. 12 is a block diagram showing an example of a functional configuration of the management apparatus 100 for performing the above-described operation. Each function of FIG. 12 is implemented mainly by the CPU 10 of the management apparatus 100 by the CPU 10 reading and executing a program stored in the ROM 11. However, at least one of the functions may be implemented by other hardware such as a dedicated electrical circuit which is not shown in FIG. 3.

With reference to FIG. 12, the CPU 10 of the management apparatus 100 includes an instruction input unit 101 for accepting instruction input from a terminal apparatus 300 by communication with the terminal apparatus 300 by the first communication unit 13; an extracting unit 102 for extracting the IDs and device names of corresponding electrical devices 500 from a table storage unit 111 which is a storage area of the ROM 11 and which stores the overall management table shown in FIG. 10; a transmitting unit 103 for transmitting the IDs and device names of the electrical devices 500 as device information to the terminal apparatus 300 through the first communication unit 13; a requesting unit 104 for requesting an electrical device 500 for information, a change in settings, etc., through the second communication unit 14; and a response input unit 105 for accepting input of a response from the electrical device 500 through the second communication unit 14.

When the instruction input from the terminal apparatus 300 is a request for information for displaying a device list for a selected type (e.g., an air conditioner), the instruction input unit 101 passes the request to the extracting unit 102. The extracting unit 102 extracts the IDs and device names of electrical devices 500 of the selected type from the overall management table (FIG. 10) stored in the table storage unit 111. When, as described above, the overall management table includes target flags, the extracting unit 102 extracts the IDs and device names of electrical devices 500 that are classified into the specified type and that are control targets (TRUE), from the overall management table. The extracted IDs and device names of the electrical devices 500 are transmitted as device information to the terminal apparatus 300 by the transmitting unit 103.

When the instruction input from the terminal apparatus 300 is a request for information for displaying a control screen for a selected electrical device 500, the instruction input unit 101 passes the request to the requesting unit 104. The requesting unit 104 requests the selected electrical device 500 for parameters representing an ON/OFF state and states such as a mode of operation and a set temperature which are to be displayed on the control screen.

When the instruction input from the terminal apparatus 300 is an instruction to change a parameter of a selected electrical device 500, the instruction input unit 101 passes the instruction to the requesting unit 104. The requesting unit 104 requests the selected electrical device 500 to make the instructed parameter change.

When the response from the electrical device 500 is parameters representing an ON/OFF state and states such as a set mode of operation and a set temperature, the response input unit 105 passes the response to the transmitting unit 103. The transmitting unit 103 transmits the inputted information as information for displaying a control screen for the selected electrical device 500 to the terminal apparatus 300. In addition, the response input unit 105 updates the overall management table using the inputted information.

When the response from the electrical device 500 is notification that a set parameter has been changed according to an instruction from the management apparatus 100, the response input unit 105 passes the response to the transmitting unit 103. The transmitting unit 103 transmits the inputted information as information for displaying the result of the parameter change made by an instruction from the terminal apparatus 300, to the terminal apparatus 300.

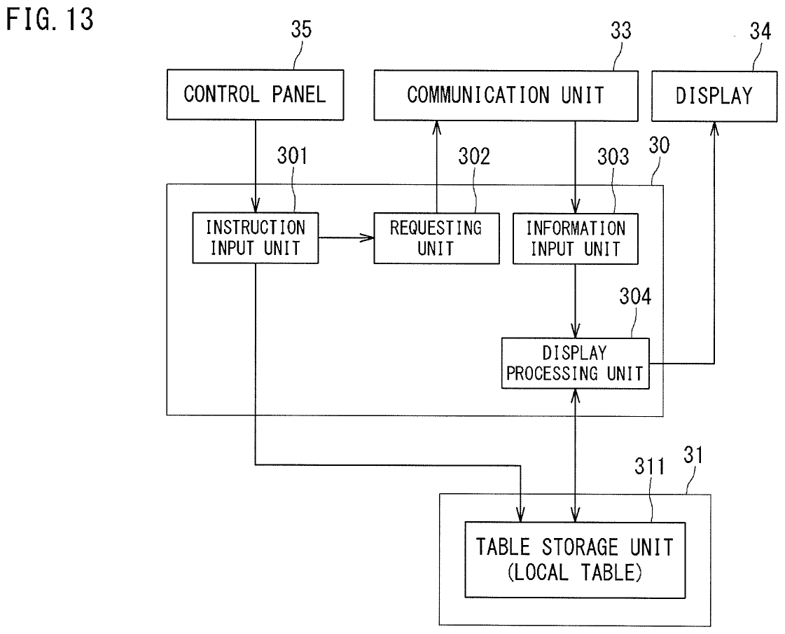

FIG. 13 is a block diagram showing an example of a functional configuration of the terminal apparatus 300. Each function of FIG. 13 is implemented mainly by the CPU 30 of the terminal apparatus 300 by the CPU 30 reading and executing a program stored in the ROM 31. However, at least one of the functions may be implemented by other hardware such as a dedicated electrical circuit which is not shown in FIG. 4.

With reference to FIG. 13, the CPU 30 of the terminal apparatus 300 includes an instruction input unit 301 for accepting instruction input by a user operation performed on the control panel 35; a requesting unit 302 for requesting the management apparatus 100 for information for screen display, a change in the settings of an electrical device 500, or the like, through the communication unit 33; an information input unit 303 for accepting input of information from the management apparatus 100 through the communication unit 33; and a display processing unit 304 for performing a process of displaying a screen on the display 34.

When the user operation performed on the control panel 35 is an instruction for screen display, the instruction input unit 302 instructs the requesting unit 302 to request information for displaying the instructed screen. Specifically, when a type (e.g., an air conditioner) is selected from the device list (FIG. 7) displayed on the display 34, the instruction input unit 301 passes information indicating the selected type to the requesting unit 302 and instructs to request information for displaying a list of electrical devices of the type. When an electrical device 500 is selected from the list of devices of the selected type (FIG. 8) displayed on the display 34, the instruction input unit 301 passes the ID of the selected electrical device 500 to the requesting unit 302 and instructs to request information for displaying a control screen for the device. The requesting unit 302 requests the management apparatus 100 for the above-described information by passing the ID passed from the instruction input unit 302.

When the user operation performed on the control panel 35 is an instruction provided on the control screen (FIG. 9) for the electrical device 500 displayed on the display 34, the instruction input unit 301 instructs the requesting unit 302 to request a change in parameter. The requesting unit 302 requests the management apparatus 100 to make the parameter change instructed by the instruction input unit 302.

When the information inputted from the management apparatus 100 is the IDs and device names of electrical devices 500 classified into a selected model, i.e., device information, the information input unit 303 passes the device information to the display processing unit 304. The display processing unit 304 displays a list of the electrical devices 500 of the selected model, using the device information. At this time, the display processing unit 304 determines the display order of the plurality of electrical devices 500 to be displayed, by referring to the local table (FIG. 11) stored in a table storage unit 311 which is a storage area of the ROM 31. Note that, when the device information inputted from the management apparatus 100 is device information of an electrical device 500 that is not registered in the local table, the display processing unit 304 displays the electrical device 500 on a list screen. In addition, the display processing unit 304 registers the electrical device 500 in the local table, and sets its position in display order to be lower than the positions in display order of other electrical devices 500 of the same type as the electrical device 500 which are stored in the local table. In addition, when device information inputted from the management apparatus 100 in response to a request for information for displaying a list of electrical devices of a selected type does not include device information of an electrical device 500 classified into the model which is registered in the local table (FIG. 11), the display processing unit 304 deletes the electrical device 500 from the local table.

When the user operation performed on the control panel 35 is an operation performed on the screen for a list of devices of a selected type (FIG. 8) and is a predefined operation such as an operation of dragging any of icons (e.g., the icons 342A to 342C) representing electrical devices 500, the instruction input unit 301 changes the display order in the local table (FIG. 11) based on the instruction. Specifically, the instruction input unit 301 identifies a movement destination of an icon that is instructed to move by a drag operation on the control panel 35, and identifies a positional relationship between the moved icon and other icons currently displayed. Then, the instruction input unit 301 identifies the display order of a plurality of electrical devices 500 represented by the icons, based on the positional relationship between the icons, and changes the local table to have the identified display order.

### Advantageous Effects of the First Embodiment

In the system according to the first embodiment, each terminal apparatus 300 stores a local table for determining display order used when electrical devices 500 are displayed. In addition, the management apparatus 100 stores an overall management table including IDs and device names for each electrical device 500 included in the system. When a terminal apparatus 300 displays electrical devices 500 on the display 34 of the terminal apparatus 300, the terminal apparatus 300 obtains and uses IDs and device names from the management apparatus 100. For example, a device name of a given electrical device 500 that is registered in the overall management table according to a user operation performed on the terminal apparatus 300A included in the system is used when the name of the electrical device 500 is displayed as a candidate for a control target on the terminal apparatus 300B. Hence, the users of the respective terminal apparatuses 300 do not need to individually perform an operation of registering a device name of an electrical device 500. This eliminates overlapping of device name registration operations by the users of the terminal apparatuses 300, enabling to improve the efficiency of operations by the users of the terminal apparatuses 300 as the entire system.

In addition, when the system includes a plurality of terminal apparatuses 300, electrical devices 500 are displayed on each terminal apparatus 300 in a display format that follows display order defined in a local table which is stored on a per-terminal-apparatus-300 basis. Hence, the display order can be customized on a per-terminal-apparatus-300 basis. By this, ease of operation by the users of the respective plurality of terminal apparatuses 300 included in the system can be improved.

### Second Embodiment

In the above-described example, on the list screen of a terminal apparatus 300 (FIG. 8) there are displayed candidate devices for the terminal apparatus 300 for each selected type. As another example, for each terminal apparatus 300, electrical devices specified by a user of the terminal apparatus 300 may be pre-registered as candidate devices for the terminal apparatus 300, regardless of type. This case will be described as a second embodiment. Note that in the following description of the second embodiment, the same parts and components as those of the first embodiment are denoted by the same reference signs. The names and functions thereof are also the same. Therefore, description thereof is not repeated.

In a system according to the second embodiment, the device list which is displayed on the terminal apparatus 300 at the above-described step S11 further includes, as shown in FIG. 7, an icon 341F for instructing to display electrical devices 500 classified into the type “my favorites”. When the icon 341F is touched, device information of all electrical devices 500 that are included in the system and that are control targets (TRUE) is requested from the terminal apparatus 300 to the management apparatus 100.

As shown in FIG. 11, in the system according to the second embodiment, the local table includes second priority levels (display order for my favorites) which are the display priorities of a plurality of electrical devices 500 including electrical devices 500 that are classified into “my favorites” and have different classification types, in addition to first priority levels which are the display priorities of a plurality of electrical devices 500 classified into the same type. To display a list, the terminal apparatus 300 uses pieces of device information of electrical devices 500 classified into “my favorites” among pieces of device information of electrical devices 500 obtained from the management apparatus 100. Specifically, with reference to FIG. 11, device information of an air conditioner with the ID “1”, device information of a light fixture with the ID “6”, and device information of a light fixture with the ID “7” are used.

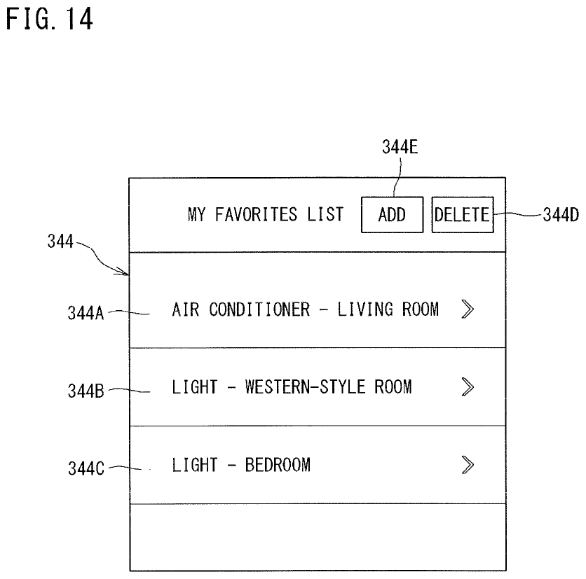

At the above-described step S14, icons representing the device names of the electrical devices 500 classified into “my favorites” are displayed in display order that follows the local table stored in the terminal apparatus 300. FIG. 14 is a diagram showing an exemplary screen for a list of electrical devices 500 classified into “my favorites” which is displayed on the terminal apparatus 300 according to the second embodiment. With reference to FIG. 14, specifically, by referring to the local table of FIG. 11, the display order of icons 344A to 344C representing the respective electrical devices 500 classified into “my favorites” is determined such that ID “1”→ID “6”→ID “7”. Then, on the terminal apparatus 300, the icon 344A representing the air conditioner in the name “living room”→the icon 344B representing the light fixture in the “Western-style room”,→the icon 344C representing the light fixture in the “bedroom” are displayed in list format in this order in an area 344 of the display screen of FIG. 14, according to the above-described order of IDs (FIG. 14).

Note that for the electrical devices 500 classified into “my favorites” in the terminal apparatus 300, too, addition or deletion may be performed according to a user operation performed on the terminal apparatus 300. For example, when, with any of the icons 344A to 344C displayed on the list screen of FIG. 14 being touched, a button 344D for instructing to delete an electrical device 500 classified into “my favorites” which is included in the list screen of FIG. 14 is touched, information of the selected electrical device 500 may be deleted from the local table stored in the terminal apparatus 300.

In addition, for example, when a button 344E for instructing to add an electrical device 500 classified into “my favorites” which is included in the list screen of FIG. 14 is touched, the terminal apparatus 300 may add information of a new electrical device 500 to the local table. In this case, device information of all electrical devices 500 that are included in the system and that are control targets (TRUE) is requested from the terminal apparatus 300 to the management apparatus 100. In the terminal apparatus 300 having obtained the device information of the corresponding electrical devices 500 from the management apparatus 100, all of the obtained electrical devices 500 are classified into “my favorites” and registered at lower positions in display order for “my favorites” in the local table. Hence, all of the obtained electrical devices 500 are displayed on the screen for a list of electrical devices in “my favorites”. By accepting thereafter a user operation for deletion such as that described above, only those electrical devices 500 selected by user operations are classified into “my favorites”. In addition, the display order of the electrical devices classified into “my favorites” may be changed by the same process as the process of changing display order which is described in the first embodiment.

### Advantageous Effects of the Second Embodiment

In the system according to the second embodiment, electrical devices 500 classified into “my favorites” are registered in a local table stored in each terminal apparatus 300. By this, electrical devices 500 classified into “my favorites” on a per-terminal-apparatus-300 basis are displayed on a terminal apparatus 300 in display order defined in the local table stored in the terminal apparatus 300. Hence, for each terminal apparatus 300, only electrical devices 500 which are candidate devices for the terminal apparatus 300 can be displayed with a simple operation, and the display order thereof can be customized. By this, ease of operation by the users of the respective plurality of terminal apparatuses 300 included in the system can be further improved.

### Third Embodiment

To implement display on a terminal apparatus 300 such as that described in the first and second embodiments, an overall management table including the IDs and device names of respective electrical devices 500 such as that shown in FIG. 10 needs to be stored in the management apparatus 100. A process of registering a device name of a new electrical device 500 in the overall management table may be performed, for example, based on an instruction from any of the terminal apparatuses 300 included in the system, as described above. This case will be described as a third embodiment. Note that in the following description of the third embodiment, the same parts and components as those of the first and second embodiments are denoted by the same reference signs. The names and functions thereof are also the same. Therefore, description thereof is not repeated.

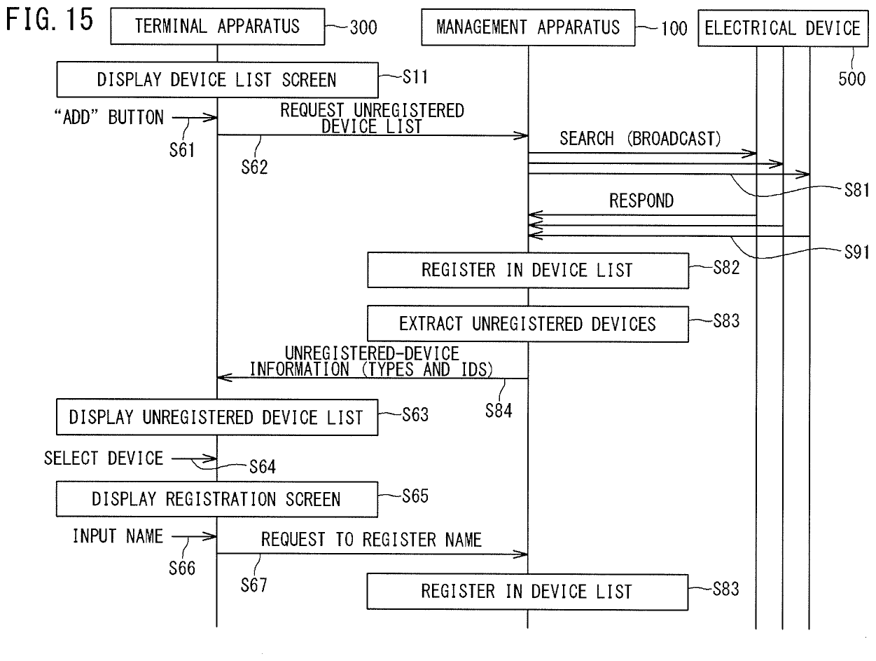

FIG. 15 is a diagram showing a summary of operation performed when a device name of an electrical device 500 is registered in the overall management table in a system according to the third embodiment. With reference to FIG. 15, in a given terminal apparatus 300, in a state in which the device list (FIG. 7) is displayed on the display 34 in the same manner as at the above-described step S11, when a button 341G for instructing to add registration in the overall management table which is shown in FIG. 7 is touched (step S61), the following operation starts. Namely, when the button 341G is touched, information for displaying, in list format, electrical devices 500 whose device names are not registered in the overall management table is requested from the terminal apparatus 300 to the management apparatus 100 (step S62).

In response to the above-described request, the management apparatus 100 searches for electrical devices 500 newly installed in the facility. As an example, the management apparatus 100 multicasts a search signal requesting a response from electrical devices 500 (step S81) and waits for responses from electrical devices 500 in the facility. When a response is received from each electrical device 500 (step S91), electrical devices 500 that are not registered in the overall management table are given IDs and registered in the overall management table. At this time, the electrical devices 500 do not serve as control targets (FALSE). Preferably, the management apparatus 100 automatically gives IDs according to the order of registration in the overall management table. In this case, it can be said that the IDs given to the electrical devices 500 are information identifying the order (registration order) in which pieces of identification information of the electrical devices 500 are registered in the overall management table. In other words, the registration order of the electrical devices 500 in the overall management table is identified based on the IDs. Note that IDs may be given independently of registration order (e.g., randomly). In this case, the overall management table further includes information indicating the order in which identification information is registered in the overall management table. The information indicating registration order is, for example, information indicating a registration date and time.

Thereafter, pieces of device information (IDs) of electrical devices 500 whose device names are not registered are extracted from the overall management table (step S83), and the pieces of device information are transmitted from the management apparatus 100 to the terminal apparatus 300 (step S84). At step S83, pieces of device information of the electrical devices that are registered in the overall management table at the above-described step S82 are also extracted. When device names of electrical devices 500 that do not serve as control targets (FALSE) are not registered in the overall management table, preferably, at step S83, pieces of device information of electrical devices 500 that are already registered without serving as control targets (registered as FALSE) are also extracted in addition to the pieces of device information of the electrical devices 500 newly registered in the overall management table. All of those electrical devices 500 correspond to electrical devices 500 whose device names are unregistered.

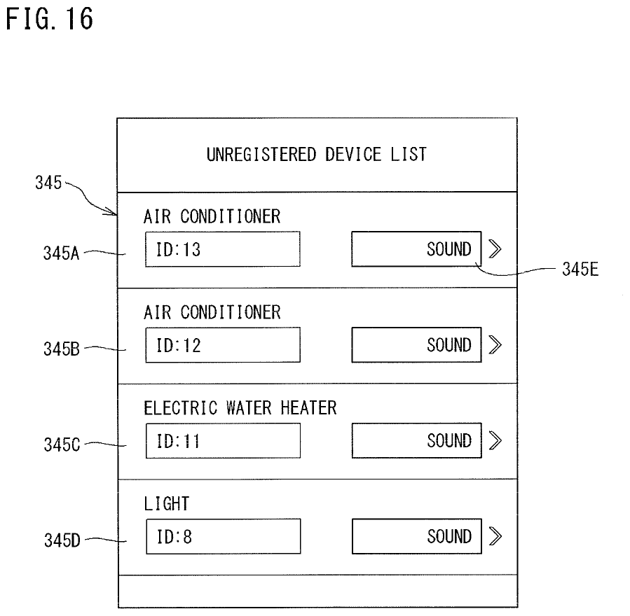

When the pieces of device information are obtained from the management apparatus 100, a screen for a list of the electrical devices 500 whose device names are unregistered is displayed on the display 34 of the terminal apparatus 300 (step S63). FIG. 16 is a diagram showing a specific example of a screen for a list of electrical devices 500 whose device names are unregistered. With reference to FIG. 16, the screen for a list displayed on the display 34 includes an area 345 for displaying a list of corresponding electrical devices 500. In the area 345 there are displayed, for example, an icon 345A representing an electrical device given the ID “13” and classified into the type “air conditioner”, an icon 345B representing an electrical device given the ID “12” and classified into the type “air conditioner”, an icon 345C representing an electrical device given the ID “11” and classified into the type “electric water heater”, and an icon 345D representing an electrical device given the ID “8” and classified into the type “light fixture”. Note that when, as shown in FIG. 10, the overall management table includes information unique to devices such as the MAC addresses, serial numbers, or manufacturing numbers of electrical devices 500, the management apparatus 100 may display corresponding information unique to devices instead of IDs. That is, the identification information of an electrical device 500 is not limited to an ID, and may be other information unique to a device such as a MAC address or a serial number.

Preferably, to display the screen for a list of FIG. 16, at step S63, the terminal apparatus 300 determines priorities in the display order of the icons 345A to 345D displayed in the area 345. As an example, the terminal apparatus 300 determines the priorities of the icons 345A to 345D in the order determined based on the registration order of identification information in the overall management table. In this case, for example, higher display priorities are determined for icons representing electrical devices 500 whose registration timing of identification information in the overall management table is later, i.e., electrical devices 500 whose identification information is registered in the overall management tab more recently. When, as described above, electrical devices 500 that do not serve as control targets (FALSE) of the terminal apparatuses 300 included in the system are also registered in the overall management table and device names have not been set for the electrical devices 500, the electrical devices 500 can also serve as targets for setting device names. In this case, it is considered that electrical devices 500 whose identification information is registered in the overall management table more recently have a higher likelihood that device names, etc., are registered in the current operation. When this idea is taken, by setting higher display priorities for icons representing electrical devices 500 whose identification information is registered in the overall management table more recently, ease of operation by a user who sets a device name can be improved. When, as described above, IDs are given to each electrical device 500 according to timing at which identification information is registered in the management apparatus 100, timing of registration in the management apparatus 100 can be determined based on the IDs. That is, as shown in FIG. 16, upon displaying the screen for a list, the terminal apparatus 300 displays corresponding icons in descending order of the ID of an electrical device 500. When the overall management table includes information indicating timing at which identification information is registered, the terminal apparatus 300 displays the screen for a list based on the information.

In addition, preferably, the screen for a list of FIG. 16 further includes a button 345E for instructing a corresponding displayed electrical device 500 to perform an informing action. The informing action is an action that stimulates the user's five senses and is, for example, sounding. Other examples of the informing action include turning on of a light or turning on of the electrical device 500. When the button 345E is touched, the corresponding electrical device 500 is instructed to perform the action by the terminal apparatus 300 through the management apparatus 100. By this, electrical devices 500 can be identified not only by displaying of the electrical devices 500 on the screen for a list of FIG. 16, but also by whether each electrical device 500 performs an instructed informing action. For example, it may be difficult to identify an electrical device 500 with only an ID being displayed on the screen for a list of FIG. 16. For example, when a plurality of electrical devices 500 classified into the same type are displayed, it may be difficult to figure out correspondence with each individual electrical device 500. By allowing to perform an informing action in such a case, the user of the terminal apparatus 300 can know a corresponding electrical device 500 with a simple operation.

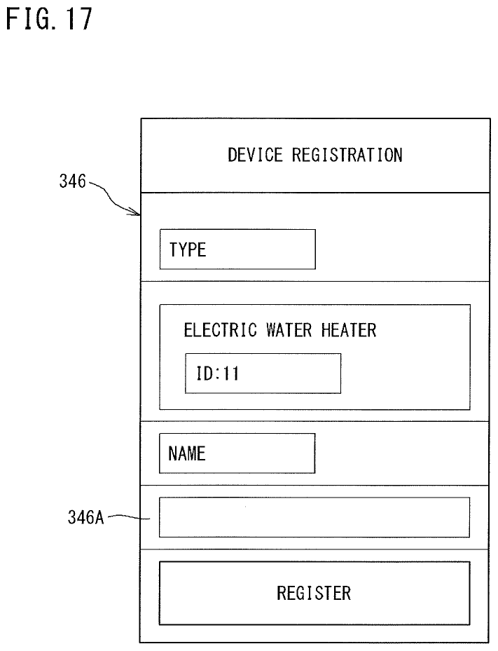

When any of the icons is selected from the screen for a list of FIG. 16 (step S64), the screen for a list of FIG. 16 transitions to a screen for registering a device name of an electrical device 500 represented by the icon (step S65). Then, on the screen, input of a device name of the electrical device 500 is accepted (step S65). For example, when the icon 345C representing the electric water heater with the ID “11” is selected on the screen for a list of FIG. 16, the screen for a list of FIG. 16 transitions to a screen for registration of FIG. 17. With reference to FIG. 17, the screen for registration includes an area 346 for displaying information of an electrical device 500 to be registered, and the area 346 includes an area 346A for accepting input of a device name of the electrical device 500.

When input of characters, etc., into the area 346A is accepted and an instruction to register this information as a device name is accepted (step S66), registration of the device name is requested from the terminal apparatus 300 to the management apparatus 100 (step S67). In response to the request from the terminal apparatus 300, the management apparatus 100 adds the inputted device name to information of the corresponding electrical device 500 in the overall management table, and changes its target flag from FALSE indicating “not a control target” to TRUE indicating “a control target” (step S83).

Note that displaying of an electrical device 500 on the terminal apparatuses 300 may be deleted according to a user operation on any of the terminal apparatuses 300 included in the system. This corresponds, for example, to a case of disposal of an installed electrical device 500. As an example, when, on the list display screen for the type “icon” shown in FIG. 8, a button 342D for instructing to delete which is shown in FIG. 8 is touched and the icon 342A representing the air conditioner in the “living room” is further touched, deletion of the device name is requested from the terminal apparatus 300 to the management apparatus 100. In response to the request from the terminal apparatus 300, the management apparatus 100 deletes the device name from information of the corresponding electrical device 500 in the overall management table, and changes its target flag from TRUE indicating “a control target” to FALSE indicating “not a control target”. By this, the electrical device 500 is no longer displayed not only on the terminal apparatus 300 on which the user operation has been performed, but also on all terminal apparatuses 300 included in the system.

### Advantageous Effects of the Third Embodiment

In the system according to the third embodiment, a device name of an electrical device 500 is set and registered in the overall management table, according to a user operation on any of the terminal apparatuses 300 included in the system. The device name registered in the overall management table can be obtained by any of the terminal apparatuses 300 included in the system and used to display a screen for control. Hence, the users of the respective terminal apparatuses 300 do not need to individually perform an operation for registering a device name of an electrical device 500 in the overall management table. This eliminates overlapping of device name registration operations by the users of the terminal apparatuses 300, enabling to improve the efficiency of operations by the users of the terminal apparatuses 300 as the entire system.

In addition, as with the registration of a device name, deletion of a registered device name from the overall management table is also performed according to a user operation on any of the terminal apparatuses 300 included in the system. Hence, the users of the respective terminal apparatuses 300 do not need to individually perform an operation for deleting a device name of an electrical device 500 from the overall management table. This eliminates overlapping of device name deletion operations by the users of the terminal apparatuses 300, enabling to improve the efficiency of operations by the users of the terminal apparatuses 300 as the entire system.

Note that, in the above first to third embodiments, electrical devices are shown as an example of energy consumption devices. The energy consumption devices are not limited to electrical devices and may be, for example, devices that consume other energy such as town gas, hydrogen gas, or a combination thereof. Even when the management targets of the management apparatus 100 of the system are energy consumption devices that consume other energy, device control can be performed by the same processes as those described above. That is, in the present disclosure, management-target devices are not limited to only electrical devices, and may be energy consumption devices that consume other energy, or energy consumption devices that consume a combination of a plurality of other types of energy.

Features disclosed in the above first to third embodiments are implemented by one or more modules. For example, the features can be implemented by circuit elements and other hardware modules, or by a software module that defines processes that implement the features, or by a combination of a hardware module and a software module.

The above-described operation can also be provided as a program to be executed by the CPUs 30 of the terminal apparatuses 300 or the CPU 10 of the management apparatus 100, the program being a combination of one or more software modules. Such a program can also be provided as a program product by recording the program in a computer-readable recording medium such as a flexible disk, a compact disk-read only memory (CD-ROM), a ROM, a RAM, or a memory card which is attached to a computer. Alternatively, the program can also be provided by recording the program in a recording medium such as a hard disk included in a computer. In addition, the program can also be provided by downloading through a network.

Note that the program according to the present disclosure may be a program that calls necessary modules among program modules provided as a part of a computer's operating system (OS), in a predetermined sequence and at predetermined timing, and allows the called modules to perform processes. In that case, the program itself does not include the above-described modules, and processes are performed in cooperation with the OS. Such a program that does not include modules can also be included in the program according to the present disclosure.

In addition, the program according to the present disclosure may be provided incorporated in a part of another program. In that case, too, the program itself does not include modules included in the above-described another program, and processes are performed in cooperation with this another program. Such a program that is incorporated in another program can also be included in the program according to the present disclosure.

The program product to be provided is installed in a program storage unit such as a hard disk, and executed. Note that the program product includes the program itself and a recording medium having the program recorded therein.

The embodiments disclosed herein are to be considered in all respects as illustrative and not restrictive. The scope of the present invention is indicated by the claims rather than by the above-described description, and all changes which come within the meaning and range of equivalency of the claims are therefore intended to be embraced therein.

### REFERENCE SIGNS LIST

10 and 30: CPU

11 and 31: ROM

12 and 32: RAM

13: FIRST COMMUNICATION UNIT

14: SECOND COMMUNICATION UNIT

33: COMMUNICATION UNIT

34: DISPLAY

35: CONTROL PANEL

341 to 346 and 346A: AREA

341A to 341F, 342A to 342C, 344A to 344C, and 345A to 345D: ICON

341G, 342D, 344D, 344E, and 345E: BUTTON

100: MANAGEMENT APPARATUS

101: INSTRUCTION INPUT UNIT

102: EXTRACTING UNIT

103: TRANSMITTING UNIT

104: REQUESTING UNIT

105: RESPONSE INPUT UNIT

111: TABLE STORAGE UNIT

300, 300A, 300B, and 300C: TERMINAL APPARATUS

301: INSTRUCTION INPUT UNIT

302: REQUESTING UNIT

303: INFORMATION INPUT UNIT

304: DISPLAY PROCESSING UNIT

311: TABLE STORAGE UNIT

500: ELECTRICAL DEVICE

501, 501A, 501B, and 501C: AIR CONDITIONER

503, 503A, 503B, and 503C: LIGHT FIXTURE

700: SERVER

1-13 (canceled)

14. A method for controlling an air conditioner, the method comprising:
requesting a list of one or more air conditioners installed in a facility;
receiving identification information and device name for each air conditioner of the one or more air conditioners installed in the facility;
associating a device name and a display order of the one or more air conditioners using the identification information registered in a local table; and
displaying, on a display, a list of the device names for each air conditioner of the one or more air conditioners installed in the facility based on the display order in the local table.

15. The method according to claim 14, further comprising:
receiving, from a user, a selection of an air conditioner displayed on the display;
requesting a state of the selected air conditioner;
receiving the state of the selected air conditioner; and
displaying, on the display, the state of the selected air conditioner.

16. The method according to claim 15, further comprising:
requesting a change to a setting of the selected air conditioner;
receiving a response to the requested change when the setting of the selected air conditioner is changed; and
displaying, on the display, the change to the setting of the selected air conditioner.

17. A communication control method performed by a communication system including a management apparatus that can communicate with a plurality of energy consumption devices, the plurality of energy consumption devices consume one or more of energy and a combination of a plurality of types of energy, and a terminal apparatus that can communicate with the management apparatus and that controls one or more of the plurality of energy consumption devices through communication with the management apparatus, the communication control method comprising:
storing, by the management apparatus, an overall management table including pieces of identification information and device names of each of the plurality of energy consumption devices, the identification information being information by which the energy consumption device can be identified, and the device name being a name of the energy consumption device; and
transmitting, by the management apparatus for storage by the terminal device in a local table, some or all of the pieces of identification information and device names of each of the plurality of energy consumption devices to the terminal apparatus, the pieces of identification information and the device names being included in the overall management table,
wherein the terminal apparatus is configured to display the device names associated with the received pieces of identification information, according to corresponding display priority levels included in the local table.

18. The communication control method according to claim 17, further comprising:
receiving, by the management apparatus, a device name together with identification information of an energy consumption device of the plurality of energy consumption devices when the terminal controller accepts a user operation for setting the device name of the energy consumption device.

19. The communication control method according to claim 17, further comprising:
transmitting, by the management apparatus, identification information and a device name of an energy consumption device of the plurality of energy consumption devices to a second terminal apparatus, the identification information and the device name being received from a first terminal apparatus and registered in the overall management table.

20. The communication control method according to claim 17, further comprising:
receiving, by the management apparatus from the terminal controller, a request for registration when the terminal controller accepts a user operation for instructing to register a new device name in the overall management table; and
transmitting, by the management apparatus in response to the received request, identification information of one or more corresponding energy consumption devices to the terminal apparatus having made the request.

21. The communication control method according to claim 20, further comprising:
searching, by the management apparatus in response to the received request, for an energy consumption device whose identification information is not registered in the overall management table, as the corresponding energy consumption device; and
registering identification information of the energy consumption device in the overall management table.

22. The communication control method according to claim 20, wherein
the overall management table further includes information identifying registration order of the identification information in the overall management table, and
wherein the method further comprises:
transmitting, by the management apparatus in response to the received request, the identification information and information of the corresponding energy consumption device to the terminal apparatus, the information identifying the registration order.

23. The communication control method according to claim 20, further comprising:
receiving, by the management apparatus from the terminal controller, a request for the management apparatus to allow an energy consumption device of the plurality of energy consumption devices specified by a user operation to perform a predefined informing action when the terminal controller accepts the predefined user operation for accepting setting of the new device name.

24. A communication system comprising:
a management apparatus that can communicate with a plurality of energy consumption devices, the plurality of energy consumption devices consume one or more of energy and a combination of a plurality of types of energy; and
one or more terminal apparatuses that can communicate with the management apparatus and that control one or more of the plurality of energy consumption devices through communication with the management apparatus, wherein
the management apparatus includes:
a management storage that stores an overall management table including pieces of identification information and device names of each of the plurality of energy consumption devices, the identification information being information by which the energy consumption device can be identified, and the device name being a name of the energy consumption device; and
a communicator that communicates with the each of the one or more terminal apparatuses, the communicator transmits some or all of the pieces of identification information and device names of each of the plurality of energy consumption devices to the one or more terminal apparatuses,
the one or more terminal apparatuses include:
a terminal storage that stores a local table including the pieces of identification information of the energy consumption devices; and display priority levels indicating display priorities of the energy consumption devices, respectively;
a display that displays the device names of the energy consumption devices; and
a terminal controller that controls communication with the management apparatus and display performed by the display, and
the terminal controller controls the display to display the device names associated with the received pieces of identification information, according to corresponding display priority levels included in the local table.

25. The communication system according to claim 24, wherein when the terminal controller accepts a user operation for setting a device name of an energy consumption device of the plurality of energy consumption devices, the terminal controller transmits the device name together with identification information of the energy consumption device to the management apparatus.

26. The communication system according to claim 24, comprising two or more terminal apparatuses, wherein
the management control unit transmits identification information and a device name of an energy consumption device of the plurality of energy consumption devices to a second terminal apparatus, the identification information and the device name being received from a first terminal apparatus and registered in the overall management table.

27. The communication system according to claim 24, comprising two or more terminal apparatuses, wherein
different display priority levels can be associated with pieces of identification information of identical energy consumption devices in a first local table stored in a terminal storage of a first terminal apparatus and a second local table stored in a terminal storage of a second terminal apparatus.

28. The communication system according to claim 24, wherein
the local table further includes pieces of information identifying types into which the energy consumption devices are classified, and
the display priority levels in the local table include first priority levels, the first priority levels being display priorities of a plurality of energy consumption devices classified into a same type.

29. The communication system according to claim 28, wherein the display priority levels in the local table further include second priority levels, the second priority levels being display priorities of a plurality of energy consumption devices classified into different types.

30. The communication system according to claim 24, wherein
when the terminal controller accepts a user operation for instructing to register a new device name in the overall management table, the terminal controller requests the management apparatus for the registration,
in response to the request, the communicator transmits identification information of one or more corresponding energy consumption devices to the terminal apparatus having made the request, and
the terminal controller controls the display to display a screen for accepting setting of the new device name, based on the received identification information.

31. The communication system according to claim 30, wherein in response to the request, the communicator searches for an energy consumption device whose identification information is not registered in the overall management table, as the corresponding energy consumption device, and registers identification information of the energy consumption device in the overall management table.

32. The communication system according to claim 30, wherein
the overall management table further includes information identifying registration order of the identification information in the overall management table,
in response to the request, the communicator transmits the identification information and information of the corresponding energy consumption device to the terminal apparatus, the information identifying the registration order, and
the terminal controller controls the display unit such that information based on the received identification information is displayed on the screen for accepting setting of the new device name, according to the registration order.

33. The communication system according to claim 30, wherein when the terminal controller accepts a predefined user operation on the screen for accepting setting of the new device name, the terminal controller requests the management apparatus to allow an energy consumption device of the plurality of energy consumption devices specified by the user operation to perform a predefined informing action.
